(19) United States
(12) Patent Application Publication
(10) Pub. No.: US 2017/0228746 A1
(43) Pub. Date: Aug. 10, 2017

(54) SURVEY SYSTEM, AND TERMINAL DEVICE AND PROGRAM FOR USE IN SAME

(71) Applicant: Asahi Net, Inc., Tokyo (JP)

(72) Inventor: Masamoto MORITA, Tokyo (JP)

(21) Appl. No.: 15/496,742

(22) Filed: Apr. 25, 2017

Related U.S. Application Data
(63) Continuation of application No. PCT/JP2014/078495, filed on Oct. 27, 2014.

(51) Int. Cl. G06Q 30/02

(52) U.S. Cl. CPC G06Q 30/0203

(57) ABSTRACT

A survey system that executes a survey with respect to a plurality of terminals that gather in one or a plurality of physical spaces comprises: a questioning terminal that provides questions for survey; a plurality of responding terminals that gather in the physical space and respond to the survey; and a surveying server connected to the questioning terminal and the responding terminals via a network and transmits survey information created by the questioning terminal to the responding terminals. The questioning terminal creates survey information, and the surveying server assigns a reception identifier identifying survey information and distributes survey information to the responding terminal in advance than the reception identifier being notified to the responding terminal when the responding terminal and surveying server are in a communication range. A responding terminal is enabled to acquire survey questions and the responding terminal is enabled to send to a surveying server even when a communication environment is not available.

This application is a continuation application of International Application Number PCT/JP2014/078495 filed on Oct. 27, 2014 and designated the U.S., the entire contents of which are incorporated herein by reference.

### TECHNICAL FIELD

The present invention relates to a survey system that performs a survey on sharers of a physical space, and a terminal device and a program for use in the same.

### BACKGROUND ART

During meeting opportunities such as a concert, a theater play, a university lecture, a seminar, or the like, many participants or attendants gather in a physical space such as a theater, a classroom, a seminar room, or the like. That is, many participants or attendants share the physical space.

There are many opportunities to distribute survey sheets and collect the same in order to perform a survey on the content of a meeting from participants or attendants who share such a physical space. With such a survey, it is possible to understand the number of participants and an attendance state at the same time.

However, such a surveying process needs a considerable amount of time and many people for distribution, collection, management of aggregation, and the like of survey sheets.

On the other hand, with recent development of communication techniques, systems that perform a survey or attendance management have been proposed.

For example, the invention disclosed in Patent Literature 1 suggests an attendance management and survey management system that includes a terminal unit that has an RFID reader and writer that reads an IC card storing the ID information of a student and a radio unit possessed by a teacher. A seat in which the IC card of the student is placed on the terminal unit is displayed so as to correspond to a management device connected to the teacher's radio unit so that the attendance state is understood.

Moreover, a technique of providing a plurality of buttons on the terminal unit to enable the student to answer a survey during a lecture using the buttons is illustrated.

In the invention disclosed in Patent Literature 2, a system for accurately managing the state of attendance at a lecture and improving the efficiency of management of lectures using the attendance state is suggested. The system includes means for managing an attendance state of a user at a lecture on the basis of position information of a communication terminal and a place and time of lecture.

### CITATION LIST

### Patent Literature

Patent Literature 1: Japanese Patent Application Publication No. 2008-9558

Patent Literature 2: Japanese Patent Application Publication No. 2014-115936

### SUMMARY OF INVENTION

### Problems to be Solved by the Invention

In the invention disclosed in Patent Literature 1, a dedicated terminal unit and a wireless unit corresponding thereto are needed. Moreover, in the invention disclosed in Patent Literature 2, a communication state between a client terminal and a server needs to be secured all the time.

However, the use of radio communication in a concert, a theater play, or the like is generally prohibited. Furthermore, in lecture rooms of a university or the like, radio resources are not sufficient. Moreover, it is difficult to enable radio communication all the time under an environment where radio waves do not reach such as in a classroom in an underground.

Furthermore, in order to realize the invention of Patent Literature 2, it is needed to establish a communication environment in which communication is enabled all the time in a physical space where many people gather.

Here, in order to perform a survey from terminal devices (responding terminals) of participants/attendants, it is needed to distribute a response form that describes questions of a survey from a surveying server that aggregates and manages the survey to the responding terminals. Furthermore, it is needed to send a response to the surveying server in order to respond to the survey.

When the responding terminal acquires the questions of the survey from the surveying server (hereinafter referred to as important communication A) and a response to the survey is transmitted from the responding terminal to the surveying server (hereinafter referred to as important communication B), it is needed to have a radio communication environment between the responding terminal and the surveying server.

However, in order to enable the “important communication A” and “important communication B,” it is needed to prepare sufficient radio resources or provide a communication environment which enables radio communication even in an underground space. However, it is not easy to realize this due to costs or the like. Moreover, there is a case in which a communication environment is not able to be prepared in a place such as in a theater due to its nature.

From the above, it is therefore an object of the present invention to provide a survey system for sharers of a physical space, which enables a responding terminal to acquire survey questions and enables the responding terminal to send a response to the survey to a surveying server even when a communication environment for “important communication A” and “important communication B” is not available, and to provide a terminal device and a program for use in the same.

### Means for Solving the Problems

According to a first aspect of a survey system for sharers of a physical space according to the present invention which attains the object, there is provided a survey system that executes a survey with respect to a plurality of terminals that gather in one or a plurality of physical spaces, the survey system including: a questioning terminal that provides questions for survey; a plurality of responding terminals that gather in the physical space and respond to the survey; and a surveying server that is connected to the questioning terminal and the responding terminal via a network and transmits survey information created by the questioning terminal to the responding terminal, wherein the questioning terminal creates the survey information, and the surveying server assigns a reception identifier for specifying the survey information and distributes the survey information to the responding terminal in advance earlier than the reception identifier being notified to the responding terminal when the responding terminal and the surveying server are in a communicable range.

In the first aspect of the survey system for sharers of the physical space according to the present invention which attains the object, as a first embodiment, the surveying server has a database in which the questioning terminal and the responding terminal that responds to the survey are registered, and the surveying server transmits the survey information in advance to the responding terminal registered in the database.

In the first aspect of the survey system for sharers of the physical space according to the present invention which attains the object, as a second embodiment, the responding terminal transmits the survey response to the surveying server within a period in which the terminals gather in the physical space or in a later period when the responding terminal is in a communication environment where the responding terminal is able to connect to the surveying server.

In the first aspect of the survey system for sharers of the physical space according to the present invention which attains the object, as a third embodiment, the survey information includes a response form and information associated thereto, and the associated information has information on a person who provides the questions for the survey using the questioning terminal.

In the first aspect of the survey system for sharers of the physical space according to the present invention which attains the object, as a fourth embodiment, when providing the questions for the survey, the questioning terminal selects one response form from a plurality of predefined response forms and embeds information for specifying the selected response form in the reception identifier.

In the first aspect of the survey system for sharers of the physical space according to the present invention which attains the object, as a fifth embodiment, a checking identifier which enables checking of validity of the reception identifier is embedded in the reception identifier, and the responding terminal generates a checking identifier when inputting the reception identifier and checks the validity of the input reception identifier on the basis of the generated checking identifier and the checking identifier embedded in the reception identifier.

In the first aspect of the survey system for sharers of the physical space according to the present invention which attains the object, as a sixth embodiment, when the responding terminal creates a survey response and transmits the survey response to the surveying server, and when a communication connection with the surveying server is not available, the responding terminal saves a current time as a local submission time, and the responding terminal transmits the survey response with the local submission time attached when the communication connection with the surveying server becomes available.

In the first aspect of the survey system for sharers of the physical space according to the present invention which attains the object, as a seventh embodiment, the responding terminal or the surveying server determines the validity of the local time by comparing the local time with a time acquired by GPS.

In the first aspect of the survey system for sharers of the physical space according to the present invention which attains the object, as an eighth embodiment, the responding terminal transmits data unique to a place where the responding terminal is present to the surveying server together with the survey response.

In the first aspect of the survey system for sharers of the physical space according to the present invention which attains the object, as a ninth embodiment, in the eighth embodiment, the unique data is position information acquired by GPS, an SSID of Wi-Fi, an IP address, or beacon data acquired via Bluetooth or the like.

In the first aspect of the survey system for sharers of the physical space according to the present invention which attains the object, as a tenth embodiment, in the third embodiment, the response form includes a predefined response form having a defined form and an open-ended response form in which a questioner is able to freely set the content of the survey.

In the first aspect of the survey system for sharers of the physical space according to the present invention which attains the object, as an eleventh embodiment, in the tenth embodiment, when survey information distributed in advance is not present and communication with the surveying server is not available, a response is created using a form including only a text area in which text is able to be freely written as the predefined response form.

A non-transitory computer-readable storage medium storing therein a program for controlling execution of a survey according to the present invention which attains the object is a non-transitory computer-readable storage medium storing therein a program for controlling execution of a survey in a survey system including: a questioning terminal that provides questions for survey; a plurality of responding terminals that gather in one or a plurality of physical spaces and respond to the survey; and a surveying server that is connected to the questioning terminal and the responding terminal via a network and transmits survey information created by the questioning terminal to the responding terminal, the program including: causing the questioning terminal to create the survey; and causing the surveying server to assign a reception identifier for specifying the survey information and distribute the survey information to the responding terminal in advance earlier than the reception identifier being notified to the responding terminal when the responding terminal and the surveying server are in a communicable range.

A plurality of survey responding terminals that gather in one or a plurality of physical spaces in a survey system that executes a survey according to the present invention which attains the object are each connected to a questioning terminal that creates survey information and a surveying server that transmits the survey information created by the questioning terminal via a network, and a reception identifier for specifying the survey information created by the questioning terminal is assigned by the surveying server, and the survey information is distributed by the surveying server in advance earlier than notification of the reception identifier when the survey responding terminal and the surveying server are in a communicable range.

### BRIEF DESCRIPTION OF DRAWINGS

FIG. 1 is a schematic diagram illustrating a configuration example of a survey system according to the present invention.

FIG. 2 is a flowchart illustrating a basic flow of a surveying process of a survey system developed earlier by the present inventors.

FIG. 3A is a flowchart illustrating a first flow of a surveying process of the survey system according to the present invention.

FIG. 3B is a flowchart illustrating a second flow of the surveying process of the survey system according to the present invention.

FIG. 4A is an attendance card issuance screen and is a diagram illustrating a state in which an option “(i) Confirm attendance only” is selected in order to confirm attendance only.

FIG. 4B is a diagram corresponding to FIG. 4A, illustrating a state in which a reception number as a reception identifier assigned by a surveying server is displayed and an attendance card is issued.

FIG. 5A is a diagram illustrating an input screen displayed on a responding terminal in correspondence to selection of the option “(i) Confirm attendance only” when communication is available.

FIG. 5B is a diagram illustrating survey information displayed on the responding terminal in correspondence to selection of the option “(i) Confirm attendance only” when communication is available.

FIG. 5C is a diagram corresponding to FIG. 5B, illustrating completion of submission displayed on the responding terminal.

FIG. 6A is a diagram illustrating an input screen displayed on the responding terminal in correspondence to selection of the option “(i) Confirm attendance only” when communication is not available.

FIG. 6B is a diagram illustrating survey information distributed in advance, displayed on the responding terminal in correspondence to selection of the option “(i) Confirm attendance only” when communication is not available.

FIG. 6C is a diagram corresponding to FIG. 6B, illustrating a prompt for delayed submission displayed on the responding terminal.

FIG. 6D is a diagram illustrating survey information registered in advance, displayed on the responding terminal in correspondence to selection of the option “(i) Confirm attendance only” when communication is not available.

FIG. 6E is a diagram corresponding to FIG. 6D, illustrating a prompt for delayed submission displayed on the responding terminal.

FIG. 7A is an attendance card issuance screen and a diagram illustrating a state in which an option “(ii) Create questions (predefined closed-ended questions and open-ended questions) as well during attendance” is selected.

FIG. 7B is a diagram corresponding to FIG. 7A, illustrating a state in which a reception number as a reception identifier assigned by the surveying server is displayed and an attendance card is issued.

FIG. 8A is a diagram illustrating an input screen displayed on the responding terminal in correspondence to selection of the option “(ii) Create questions (predefined closed-ended questions and open-ended questions) as well during attendance” when communication is available.

FIG. 8B is a diagram illustrating an input screen displayed on the responding terminal in correspondence to selection of the option “(ii) Create questions (predefined closed-ended questions and open-ended questions) as well during attendance” when communication is available.

FIG. 8C is a diagram corresponding to FIG. 8B, illustrating a screen in which a response is created on a response form.

FIG. 8D corresponds to FIG. 8C and is a confirmation screen of a created response.

FIG. 8E corresponds to FIG. 8C and is a screen on which a message of completion of submission is displayed.

FIG. 9A is a diagram illustrating an input screen displayed on the responding terminal in correspondence to selection of the option “(ii) Create questions (predefined closed-ended questions and open-ended questions) as well during attendance” when communication is not available.

FIG. 9B is a diagram illustrating survey information distributed in advance, displayed on the responding terminal in correspondence to selection of the option “(ii) Create questions (predefined closed-ended questions and open-ended questions) as well during attendance” when communication is not available.

FIG. 9C is a diagram illustrating a state in which a response is created on a response form of the survey information distributed in advance in correspondence to selection of the option “(ii) Create questions (predefined closed-ended questions and open-ended questions) as well during attendance” when communication is not available.

FIG. 9D is a confirmation screen of a response created in correspondence to FIG. 9C when communication is not available.

FIG. 9E is a diagram illustrating a prompt for delayed submission displayed on the responding terminal in correspondence to FIG. 9D when communication is not available.

FIG. 10A is a diagram illustrating survey information which is not distributed in advance but registered in advance in correspondence to selection of the option “(ii) Create questions (predefined closed-ended questions and open-ended questions) as well during attendance” when communication is not available.

FIG. 10B corresponds to FIG. 10A and is a diagram illustrating a state in which a response is created on a response form of the survey information.

FIG. 10C corresponds to FIG. 10A and is a confirmation screen of a response.

FIG. 10D corresponds to FIG. 10A and is a diagram illustrating the display of delayed submission when important communication B is not available.

FIG. 11 is an attendance card issuance screen displayed when an option “(iii) Create survey (in which questions can be freely set) as well during attendance” is selected.

FIG. 12 is a survey creation screen displayed in correspondence to FIG. 11.

FIG. 13 is a diagram corresponding to FIG. 11, illustrating a state in which a reception number as a reception identifier assigned by the surveying server is displayed and an attendance card is issued.

FIG. 14A is an input screen displayed when important communication A is available in correspondence to selection of the option “(iii) Create survey (in which questions can be freely set) as well during attendance”.

FIG. 14B corresponds to FIG. 14A and is a screen of a response form displayed when important communication A is available.

FIG. 14C corresponds to FIG. 14A and is a screen of a response created when important communication A is available.

FIG. 14D corresponds to FIG. 14A and is a confirmation screen of a response created when important communication A is available.

FIG. 14E corresponds to FIG. 14D and is a screen for confirming completion of submission of response to a survey when important communication A is available.

FIG. 15A is a diagram illustrating an input screen displayed when important communication A is not available in correspondence to selection of the option “(iii) Create survey (in which questions can be freely set) as well during attendance”.

FIG. 15B is a diagram corresponding to FIG. 15A, illustrating a response form distributed in advance when important communication A is not available.

FIG. 15C is a diagram corresponding to FIG. 15A, illustrating a screen on which a response is created when important communication A is not available.

FIG. 15D corresponds to FIG. 15A and is a confirmation screen of a created response (FIG. 15C).

FIG. 15E is a diagram corresponding to FIG. 15D, illustrating the display of delayed submission when important communication B is not available.

FIG. 16A is a diagram illustrating a response form that does not contain text.

FIG. 16B is a diagram illustrating a response form which is frequently used.

### DESCRIPTION OF EMBODIMENTS

Hereinafter, an embodiment of the present invention will be described with reference to the drawings. The embodiment is provided for better understanding of the invention, and the scope of protection of the invention is not limited to this, but those described in claims and the equivalents thereof fall within the scope of protection of the present invention.

[Configuration of Survey System]

A survey system according to the present invention is a system which enables a plurality of participants or attendants (persons who respond to a survey, hereinafter referred to as responders) who gather in a physical space to send responses to the survey presented by a lecturer, a teacher, a sponsor, or the like (a person who creates a survey and aggregates the responses to the survey, hereinafter referred to as a questioner) using a program such as a web browser.

There are various purposes of a survey. For example, a survey may be performed to know how much a responder is interested in or understands the content of a seminar or a lecture. Moreover, a survey may be performed to easily understand the number of attendants when there are many responders at the same time.

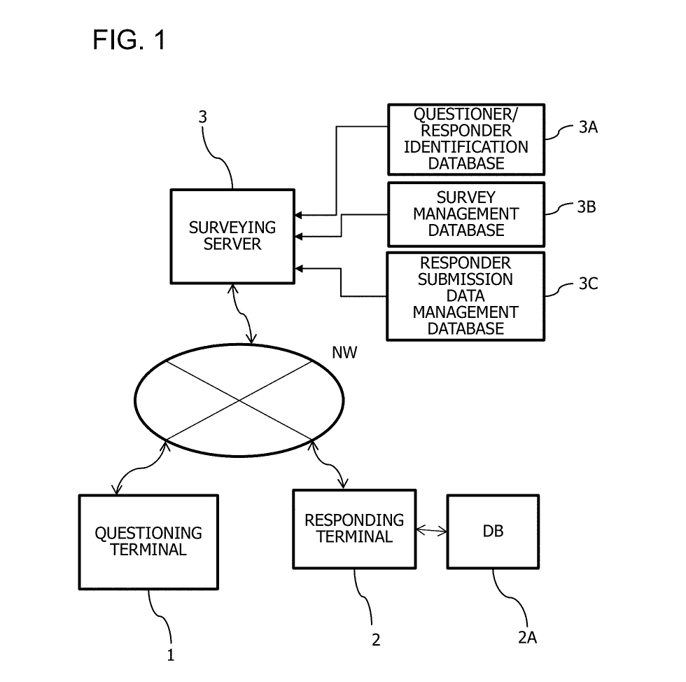

FIG. 1 is a schematic diagram illustrating a configuration example of a survey system according to the present invention. As a configuration of the survey system, as illustrated in FIG. 1, a questioning terminal 1 which is a terminal for allowing a questioner to prepare a survey, a responding terminal 2 which is a terminal for allowing a responder to send a response to the survey, and a surveying server 3 are connected via a network NW such as the Internet. The questioning terminal 1 and the responding terminal 2 have a display screen for displaying a response form or the like.

Here, a personal computer (PC) having an Internet connection function may be used as the questioning terminal 1. Moreover, a smartphone which is an intelligent terminal having a telephone function, an Internet connection function, and a PC function capable of creating and editing data may be used as an example of the responding terminal 2.

The responding terminal 2 means the respective responding terminals possessed by a plurality of responders who gather in the same physical space such as a classroom, a seminar room, or a theater and also means responding terminals of responders present in a plurality of physical spaces disposed at separate remote sites as in the case of a satellite class, for example.

In the present embodiment, the plurality of responding terminals being in these states will be referred to as a plurality of terminals gathering in a physical space.

The surveying server 3 includes various databases 3A to 3C and is an apparatus that provides a data server function for the questioning terminal 1 and the responding terminal 2.

The questioners and the responders are identified by corresponding identification codes, and the identification codes and the corresponding questioners and responders (that is, a plurality of participants or attendants who are scheduled to gather in a physical space) are registered in the database 3A.

The survey management database 3B includes a predefined survey response form having a predetermined format (hereinafter simply referred to as a predefined response form) and a survey response form (hereinafter referred to as an open-ended response form) in which a questioner is allowed to describe an open-ended question as response forms, and these response forms are registered in the database 3B.

Survey response data sent from the responder is registered in the responder submission data management database 3C.

A control program that realizes a surveying process of the survey system according to the present invention is installed on the responding terminal 2. The questioning terminal 1 can access the server 3, create a response form, and read a survey response using a browser only.

[Basic Flow of Surveying Process]

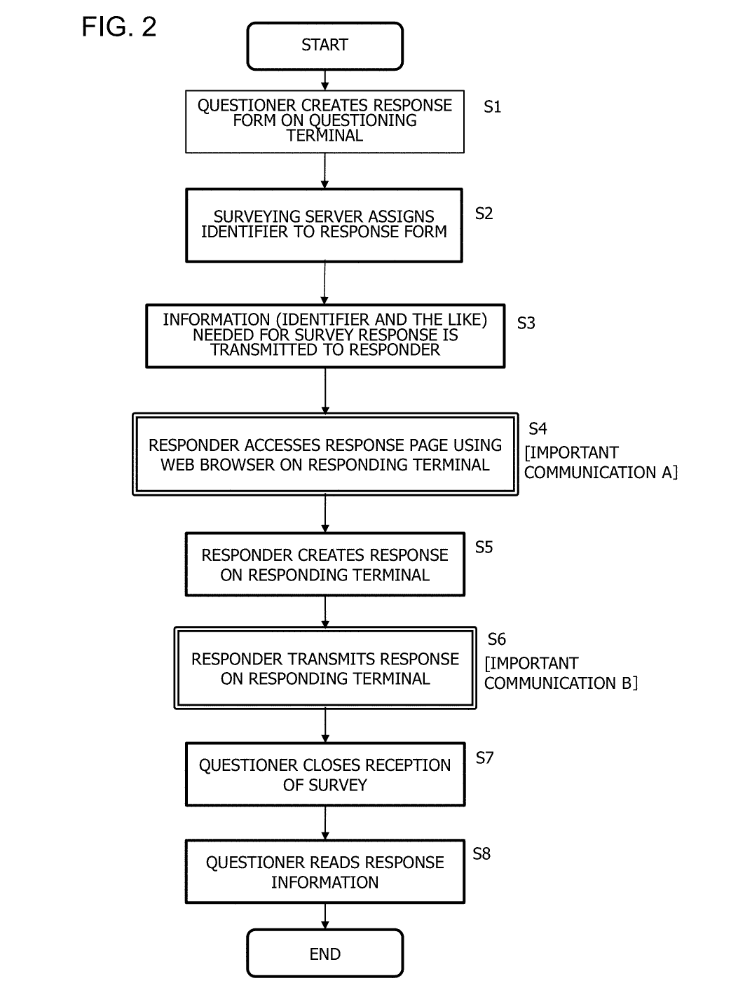

FIG. 2 is a flowchart illustrating a basic flow of a surveying process of an existing survey system developed earlier by the present inventors. In the existing survey system, the questioning terminal 1 and the responding terminal 2 use a browser only. For understanding of the present invention, an overview of the process of the existing survey system will be described.

In the description of the following embodiment, although a response form presented from a teacher in a class will be described as an example, the application of the present invention is not limited to a survey in the class.

A questioner (teacher) creates a response form using the questioning terminal 1 (step S1). The questioning terminal is a personal computer PC as an example, and the questioner creates the response form using a program such as a web browser.

The questioner accesses the surveying server 3 from the questioning terminal 1. The surveying server 3 checks the validity of the accessing questioner by an identification ID of the questioner registered in the questioner/responder database 3A. If the questioner has been registered, a connection link is established between the questioning terminal 1 and the surveying server 3.

The questioning terminal 1 creates a survey response form and registers the same in the survey management database 3B of the surveying server 3 (step S1). In this case, a “reception identifier” that specifies the survey is assigned by the surveying server 3 (step S2).

Subsequently, the questioner transmits the reception identifier assigned in advance by the surveying server 3 and an access destination (URL: Uniform Resource Locator) for acquiring a survey response form or returning response data as needed to the responder as information needed for responding to the survey in a classroom where the responder (student) is present (step S3). Retransmission of the access destination (URL: Uniform Resource Locator) for sending a response is not needed if the responder already knows the access destination.

The information needed for responding to the survey may be transmitted from the questioner to the responder via oral communication or writing on a board when the questioner and the responder are present in the same physical space (classroom) or, for example, by displaying the same on displays or the like in physical spaces via communication when, for example, the questioner and the responders are at separate remote sites such as a satellite classroom.

The responder activates a program such as a web browser installed on the responding terminal 2 and accesses a response page using the URL transmitted from the questioner (step S4). This is [important communication A] between the responding terminal 2 and the surveying server 3 performed to acquire the survey information from the surveying server 3. That is, when step S4 is to be executed, a communication connection [important communication A] for connecting the responding terminal 2 and the surveying server 3 is needed.

Here, the survey information includes a response form and information associated thereto. As described above, the response form is subdivided into a predefined response form and an open-ended response form, and the information associated to the response form includes information (name) of the questioner, a survey creation date, and the like. If the survey is performed on a groupware such as SNS, user information or the like may be assigned by the system.

When the responding terminal 2 fails in the try to establish communication connection [important communication A] with the surveying server 3 using the URL informed by the questioner, a communication failure screen is displayed on the responding terminal 2.

On the other hand, when the responding terminal 2 and the surveying server 3 are in a communicable environment, the responder inputs and transmits user identification information (a user ID and a password) and the reception identifier notified in advance from the questioner. The surveying server 3 checks the validity of the accessing responder by the identification ID of the responder registered in the questioner/responder identification database 3A. The validity check may be omitted and submission (anonymous submission) by a person who is not registered in the database 3A may be allowed.

If the responder is a valid responder who is registered in the questioner/responder identification database 3A, the survey information including a response form specified by the reception identifier and the associated information, registered in advance in the survey management database 3B by the questioner is transmitted from the surveying server 3 to the responding terminal 2.

The response form and the associated information transmitted from the surveying server 3 are displayed on the responding terminal 2, and the responder creates a response on the response form (step S5).

Subsequently, the responder transmits the created survey response data to the surveying server 3 (step S6). The transmission of the survey response to the surveying server 3 is [important communication B] for transmitting a survey response to the surveying server 3.

That is, a communication connection [important communication B] between the responding terminal 2 and the surveying server 3 is needed. When transmission of the survey response to the surveying server 3 succeeds, a submission completion screen is displayed on the responding terminal 2.

On the other hand, when the communication connection [important communication B] fails, a communication failure screen is displayed on the responding terminal 2 similarly to the case of [important communication A].

Here, in FIG. 2, the time at the surveying server 3 when transmission of a survey response from the responding terminal 2 to the surveying server 3 is completed by the [important communication B] in step S6 is “reception completion date”.

The questioner accesses the surveying server 3 from the questioning terminal 1 to perform a process of closing the reception of the survey (step S7). The survey reception closing time may be within class hours or after the class.

After the survey reception closing process is performed, the questioner accesses the surveying server 3 from the questioning terminal 1 to read the response data registered in the responder submission data management database 3C (step S8).

In this case, the questioner can download the response data to the questioning terminal 1 and read the response data. Moreover, the questioner may be allowed to read the response data registered in the responder submission data management database 3C before performing the survey reception closing process.

Here, “reception completion date” in the response data will be discussed particularly. The “reception completion date” is the time at which the surveying server 3 received the response data of the responders. The reception completion date may occur after the time at which the survey information needed for a response is transmitted from a teacher to a student via oral communication or writing on a board in step S3.

When it is prompted to transmit the response during class hours, the “reception completion date” for the transmissions of respective students may fall within the class hours.

In this manner, when the survey response also serves as an attendance confirmation, the questioner (a teacher) and the responder (a student) share the same physical space (a classroom: including a satellite classroom) at the same time (class hours). That is, under this limitation, by transmitting information needed for a response is transmitted to the responder in step S3, a situation in which it is not possible to send a response if the responders are not in the same space and at the same time is created.

As described above, in the process flow of the existing survey system, the responding terminal 2 needs to be accessible to the surveying server 3 as [important communication A] and [important communication B] in steps S2 and S6 (FIG. 2).

However, in a concert hall, an underground lecture room, or the like, it is difficult to perform communication with the outside. Moreover, when a number of participants and attendants share the same physical space, radio resources are insufficient and it is difficult to perform communication satisfactorily.

In such a case, in the above-described process flow, the responder may be unable to acquire information needed for a response from the questioner via the [important communication A] (step S2). Furthermore, the responder may be unable to transmit the created survey response data to the surveying server 3 via the [important communication B] (step S5).

Therefore, the present invention provides a measure against a case in which it is difficult to secure the [important communication A] and the [important communication B].

Hereinafter, the features of the present invention will be described in detail.

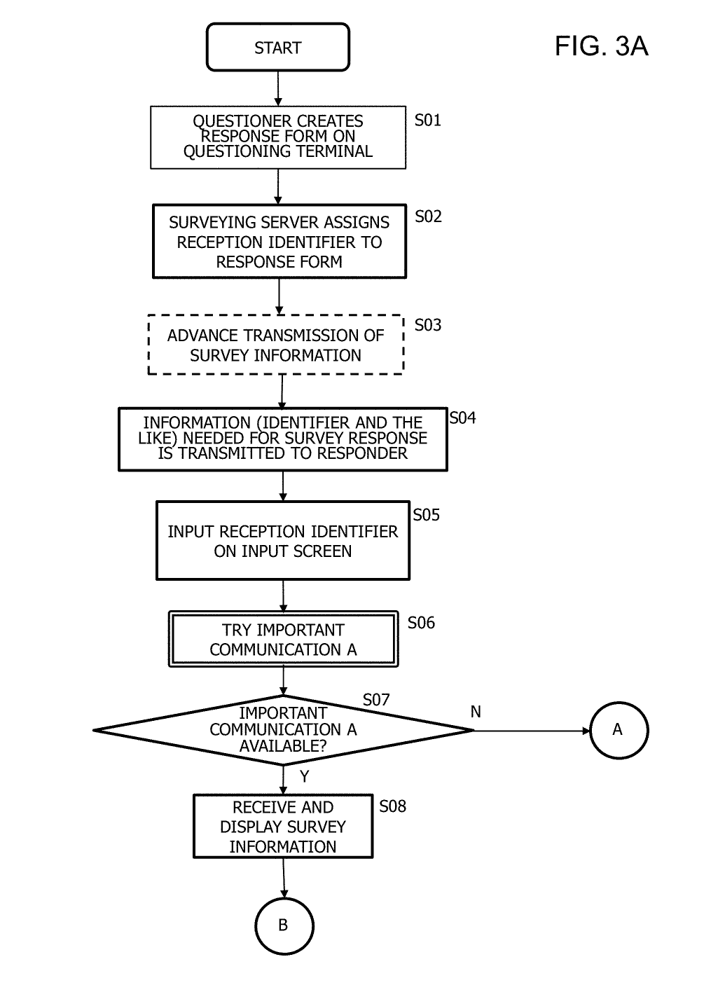

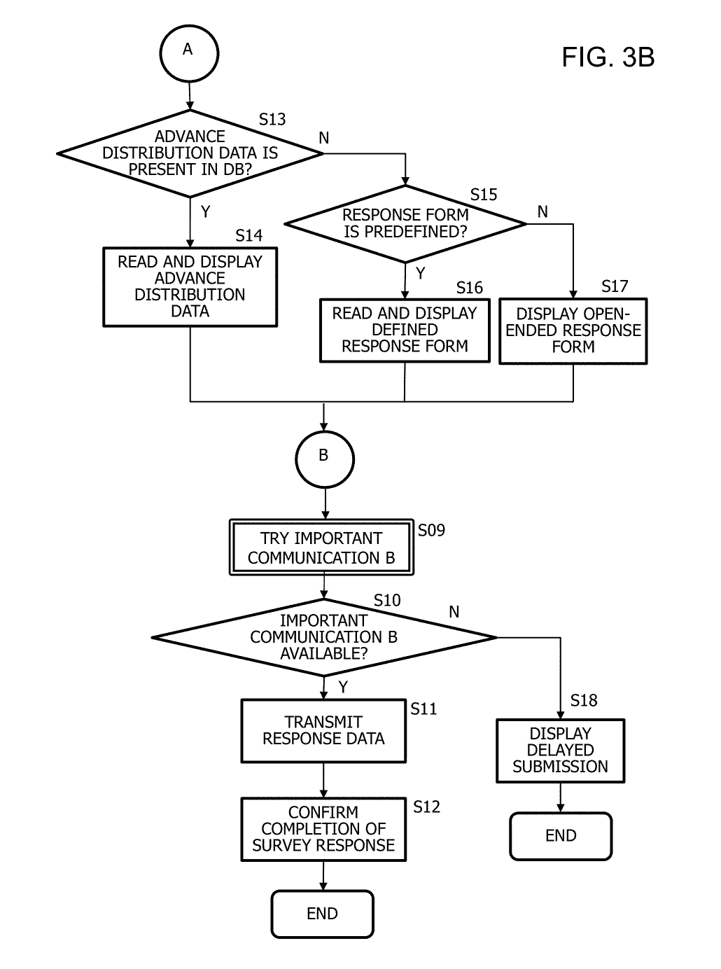

FIGS. 3A and 3B are flowcharts illustrating first and second flows of a surveying process of a survey system according to the present invention.

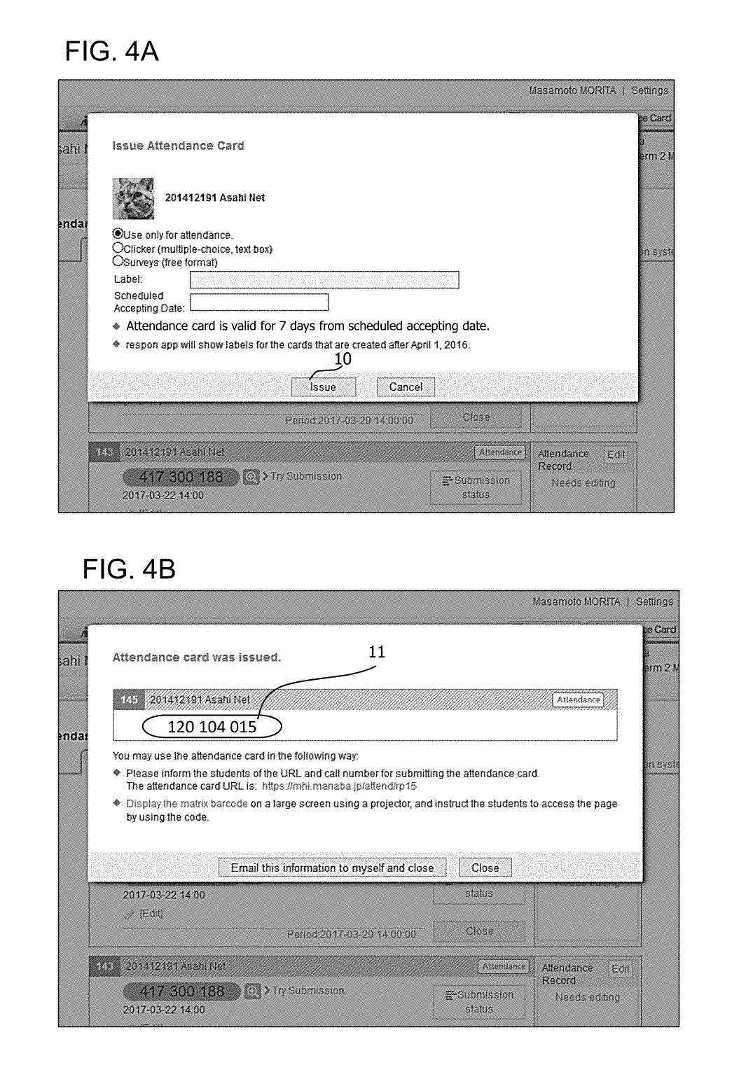

In FIG. 3A, first, a questioner creates an attendance card which is an example of a survey (step S01: FIG. 3A). FIG. 4A is an example of an issuance screen of an attendance card which is an example of a survey displayed on the questioning terminal 1. The questioning terminal 1 accesses the surveying server 3 to acquire this attendance card issuance screen from the survey management database 3B. Alternatively, the attendance card issuance screen may be registered in the questioning terminal 1 when the survey system is activated.

The attendance card issuance screen includes buttons for selecting (i) Confirm attendance only, (ii) Create questions (predefined closed-ended questions and open-ended questions) as well during attendance, and (iii) Create survey (in which questions can be freely set) as well during attendance as options. A predefined response form is used for the options (i) and (ii) and an open-ended response form is used for the option (iii).

Hereinafter, the flow of the process of the survey system according to the present invention in correspondence to respective options will be described.

[(i) Confirm Attendance Only]

FIG. 4A is an attendance card issuance screen and illustrates a state in which the option “(i) Confirm attendance only” is selected in order to confirm attendance only. In FIG. 4A, when an “issue” button 10 is pressed, a reception identifier is assigned by the surveying server 3 as illustrated in FIG. 4B. A reception number 11 as the assigned reception identifier is displayed so that it can be confirmed that an attendance card has been issued (step S02: FIG. 3A). In this case, a response form is registered in the survey management database 3B of the surveying server 3 in correspondence to the reception number 11.

The reception identifier is made up of numbers, characters, symbols, or a combination thereof. In the example illustrated in FIG. 4B, the reception number 11 made up of numbers only is illustrated as the reception identifier. In the following description, the reception identifier is displayed as a “reception number” made up of numbers only as an example.

[Advance Distribution]

Here, the survey information is distributed in advance using a reception number for identifying a survey in order to discriminate a survey which asks for a response (step S03: FIG. 3A). Therefore, the survey information including the response form created in advance by the questioner and the information associated thereto is registered in the survey management database 3B of the surveying server 3 in correlation with the assigned “reception number”.

As described above, the response form includes a predefined response form having a defined format and an open-ended response form which the questioner can freely create questions.

The information associated with these response forms may be arbitrarily written by the questioner and may be automatically assigned by the survey system. The content of the associated information includes the information (name) of the questioner, the creation date of the survey, and the like, and the user information may be assigned by the system if the survey is performed on a groupware such as SNS.

The response form and the associated information registered in the survey management database 3B are transmitted to the responding terminal 2 of the responder registered in the questioner/responder identification database 3A when the responding terminal 2 of the responder and the surveying server 3 are in a communicable range.

In this way, the survey information is automatically downloaded to the database 2A of the responding terminal 2 earlier than notification of the reception number. The timing of this download may be informed to the responder. Advance automated transmission of the response form and the associated information is referred to as “advance distribution”.

The responder can draw the response form and the associated information received in advance and maintained in the database 2A of the responding terminal 2 in correspondence to the “reception number” and display the same on a display screen of the responding terminal 2.

That is, the responder can display the survey information including the response form and the associated information on the responding terminal 2 by obtaining the “reception number” from the questioner without executing “important communication A” with the surveying server 3.

In the “advance distribution,” even when [important communication A] is not available, the responder can obtain the response form via advance distribution and display the survey information on the responding terminal 2. In this case, the type of the response form does not matter. That is, the response form may be either an open-ended response form that is arbitrarily created by the questioner or a form selected from a plurality of predefined response forms.

Here, the questioner transmits the reception number and information needed for responding to the survey to the responder as described above in FIG. 2 (step S04: FIG. 3A).

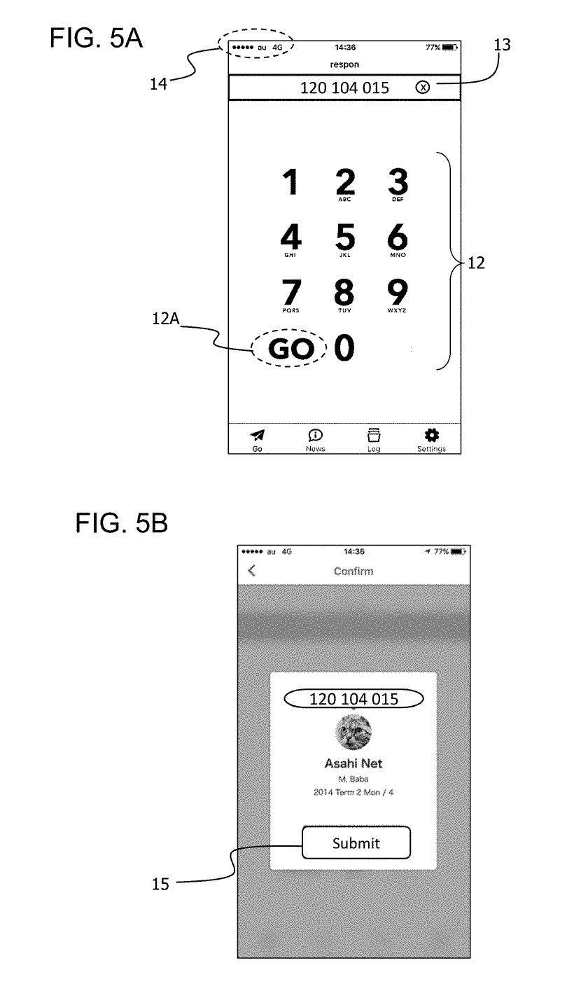

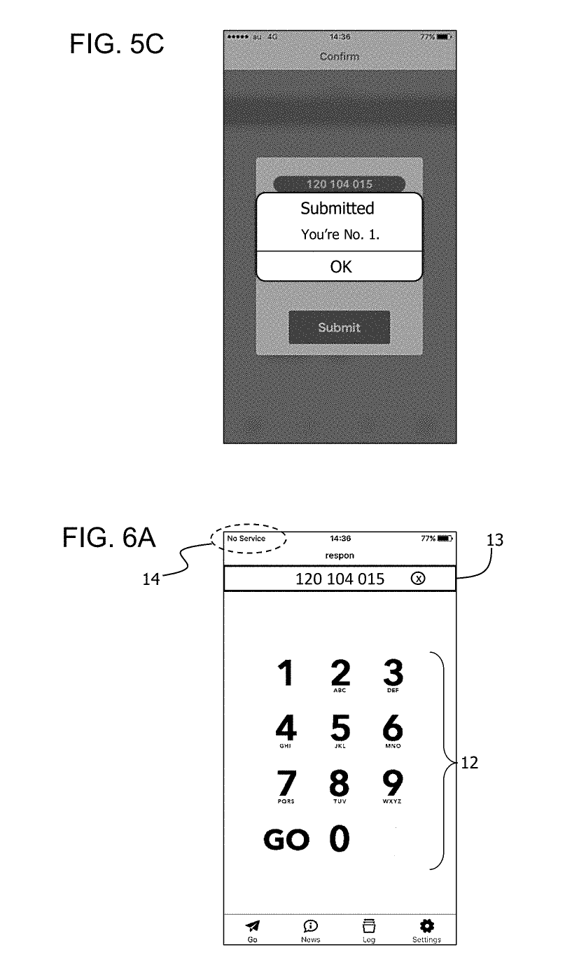

The responder displays an input screen on the responding terminal 2. The input screen is similar to that illustrated in FIG. 5A and is created and displayed by a control program installed on the responding terminal 2.

The input screen includes number keys 12 from 0 to 9 and a reception number display field 13. An indication 14 indicating whether the responder 2 and the surveying server 3 are in a communicable environment is also displayed. Although input fields for a password, an ID, and the like, for specifying the responder (the responding terminal) are not illustrated in the input screen, input of such data can be omitted by installing the same on the responding terminal 2 when the control program is installed.

In this input screen, the responder inputs the reception number 11 informed in advance from the questioner (step S05: FIG. 3A). Subsequently, the responder presses a send button 12A in the input screen of FIG. 5A to issue a transmission instruction to perform the “important communication A” (step S06: FIG. 3A).

In this case, when the responding terminal 2 and the surveying server 3 can perform communication (step S07, Y: FIG. 3A), the survey information is received from the surveying server 3, and the response form is displayed on the responding terminal 2 as illustrated in FIG. 5B (step S08: FIG. 3A).

In the response form of FIG. 5B, since an attendance card which confirms attendance only is selected by the questioner, the responder confirms a lecture name, a teacher name, an icon, and a due date and time which is the information associated to the displayed response form and presses a submit button 15 to perform the “important communication B” (step S09: FIG. 3B).

In this case, when communication [important communication B] for connecting the responding terminal 2 and the surveying server 3 is available (step S10, Y: FIG. 3B), the survey response data is transmitted to the surveying server 3 (step S11: FIG. 3B). When this important communication B succeeds, a message of completion of submission is displayed on the responding terminal 2 as illustrated in FIG. 5C and the completion of a survey response can be confirmed (step S12: FIG. 3B).

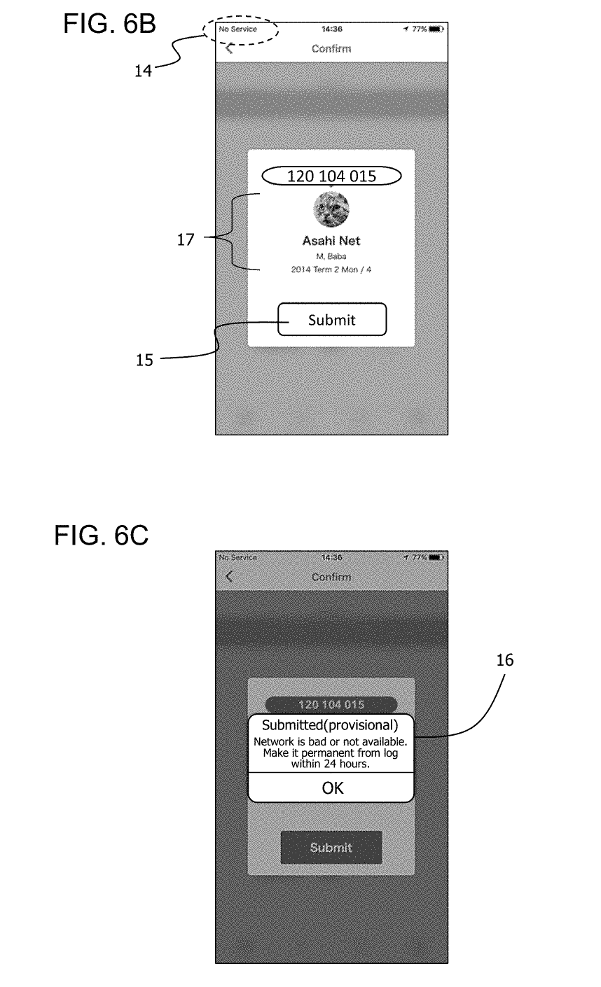

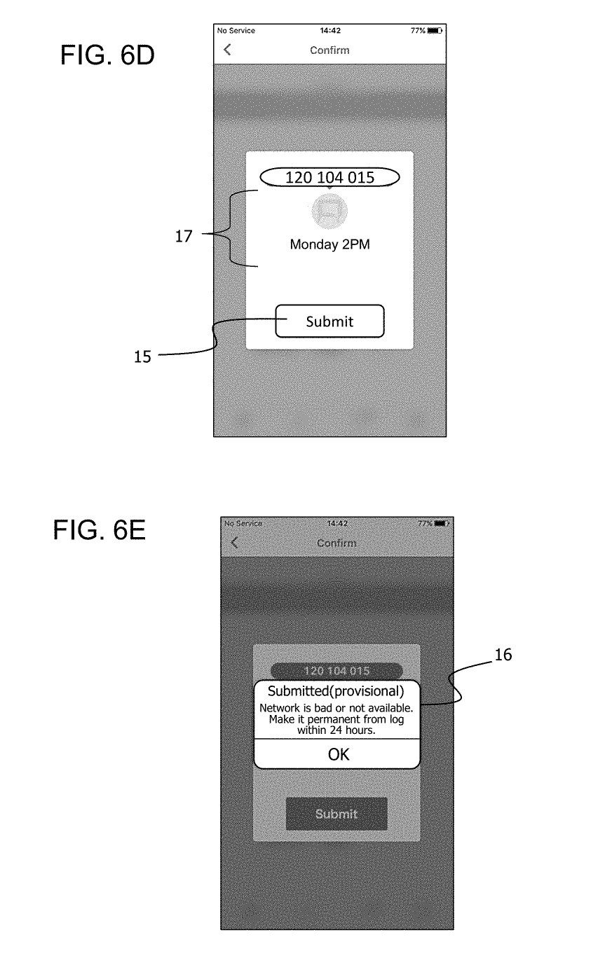

Here, returning to FIG. 3A, when the responding terminal 2 and the surveying server 3 are in a non-communicable range (step S07, N: FIG. 3A), the input screen is as illustrated in FIG. 6A, and the indication 14 indicating whether a communicable environment is established indicates the non-communicable range of no service.

Therefore, when the data of the survey information distributed in advance is present in the database 2A (step S13, Y: FIG. 3B), the responding terminal 2 reads the advance distribution data and displays a response form (step S14: FIG. 3B). The response form displayed as illustrated in FIG. 6B on the basis of the advance distribution data is similar to the response form (FIG. 5B) displayed when the “important communication A” is available.

Therefore, the responder confirms a lecture name, a teacher name, an icon, and a due date and time displayed and presses the submit button 15 to perform the “important communication B” (step S09: FIG. 3B).

In this case, when communication [important communication B] for connecting the responding terminal 2 and the surveying server 3 is available (step S10, Y: FIG. 3B), the subsequent processes are similar to the processes of steps S11 and S12.

When advance distribution data is not present in the database 2A (step S13, N: FIG. 3B), and the response form is defined in advance (step S15, Y: FIG. 3B), the response form is read from the database 2A and is displayed on the responding terminal 2 (step S16). FIG. 6D is an example of the displayed predefined response form, which is registered in advance in the database 2A. Unlike the response form displayed in FIG. 6B, the response form in FIG. 6D does not have advance distribution data and an indication 17 of associated information (a lecture name, a teacher name, an icon, and a due date and time) is not present.

Furthermore, when the important communication B is not available (step S09, N: FIG. 3B), a message of delayed submission 16 is displayed as illustrated in FIGS. 6C and 6E (step S18).

A message such as “Your card is saved due to poor communication state. Please try transmission in good communication state within 24 hours” is added to the delayed submission display field.

The delayed submission will be described again later as one of the features of the present invention.

[(ii) Create Questions (Predefined Closed-Ended Questions and Open-Ended Questions) as Well During Attendance]

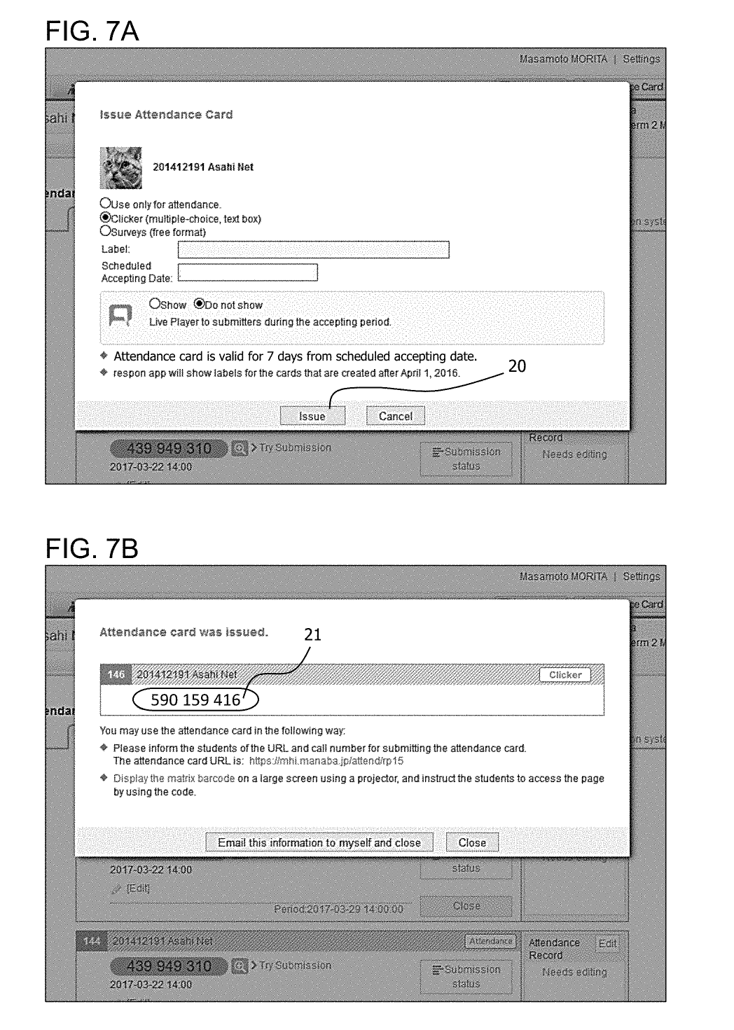

FIG. 7A is an attendance card issuance screen in which the option “(ii) Create questions (predefined closed-ended questions and open-ended questions) as well during attendance” executed to ask for a response to a predefined question during attendance confirmation is selected.

When an “issue” button 20 is pressed, a reception number 21 is assigned as a reception identifier by the surveying server 3 as illustrated in FIG. 7B so that it can be confirmed that an attendance card has been issued (step S02: FIG. 3A).

In this case, a response form is registered in the survey management server 3B of the surveying server 3 in correspondence to the reception number 21. The reception number 21 is different from that used when the option “(i) Confirm attendance only” is selected, and therefore, a different response form is identified.

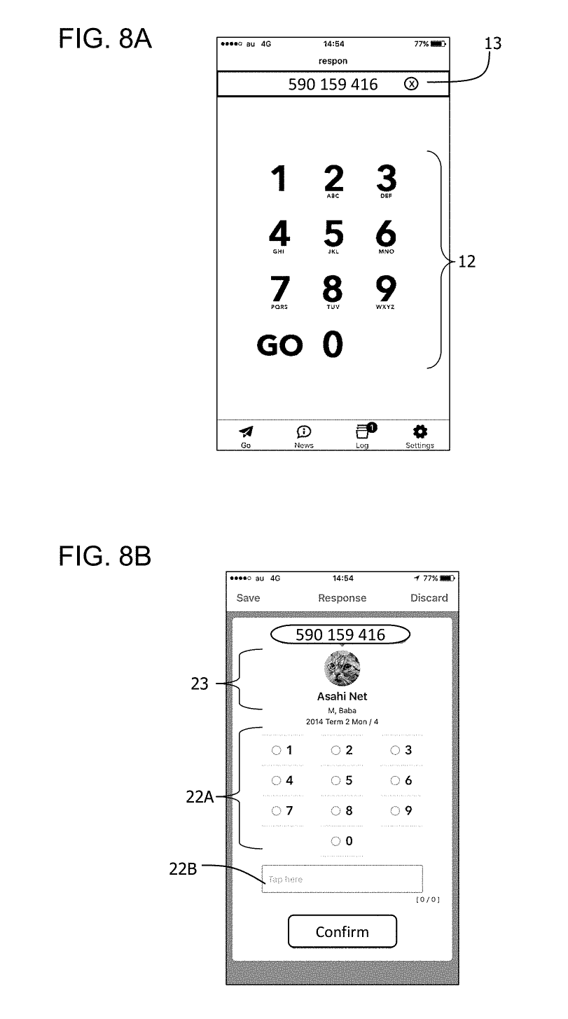

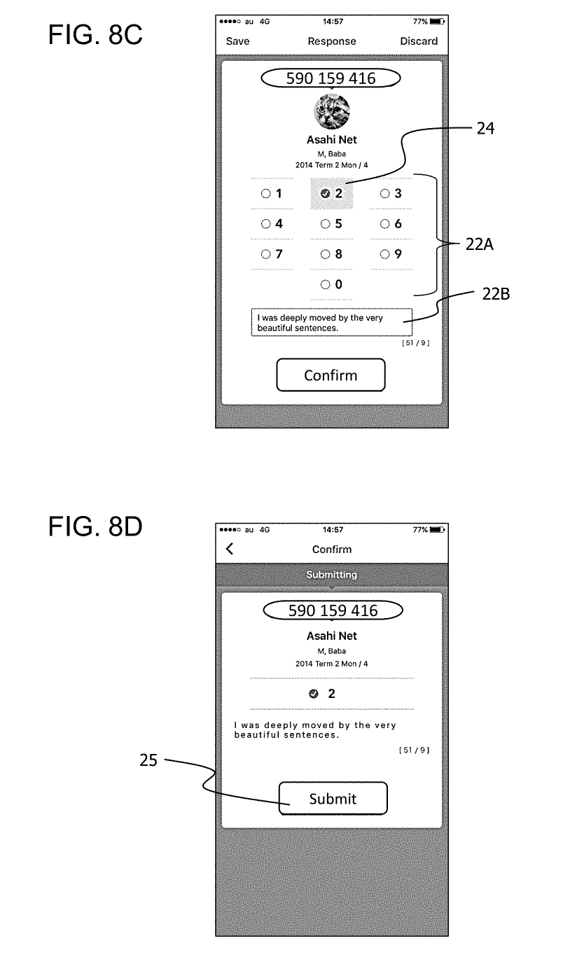

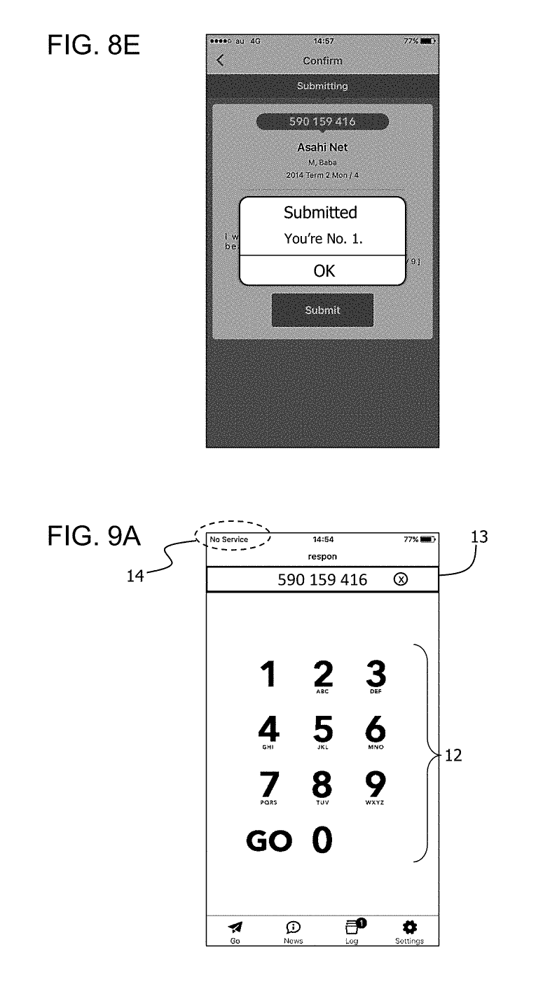

FIGS. 8A to 8C illustrate an input screen (FIG. 8A), a response form (FIG. 8B), and a screen (FIG. 8C) on which a response is created when the important communication A is available (step S07, Y). Although no question is described in this response form (FIG. 8B), it is assumed that a teacher asks questions orally. For example, this response form is used to orally indicate that “Please select “1” for YES or “2” for No and write down the reasons therefor” with respect to a question orally asked by a teacher.

The input screen (FIG. 8A) is similar to the input screen used when the option “(i) Confirm attendance only” is selected except for the input reception number only.

The response form of FIG. 8B is received from the database 3B of the surveying server 3 in correspondence to the input reception number when the responding terminal 2 and the surveying server 3 can communicate (step S08: FIG. 3A). The response form includes number input buttons 22A from 1 to 9 and 0, associated information 23 including the information on a lecture name, a teacher name, an icon, and a due date and time, and a free description field 22B.

When the important communication B is available (step S10: FIG. 3B), as illustrated in FIG. 8C, the responder inputs a number (for example, number 2) selected for a question orally asked by a teacher, for example, and writes a sentence into the free description field 22B to create a response.

FIG. 8D is a confirmation screen for confirming the created response, and the responder presses a submit button 25 to transmit response data to the surveying server 3 (step S11: FIG. 3B). Subsequently, when transmission to the surveying server 3 is completed, a submission completion message is displayed (FIG. 8E), and the completion of transmission of the survey data is confirmed (step S12: FIG. 3B).

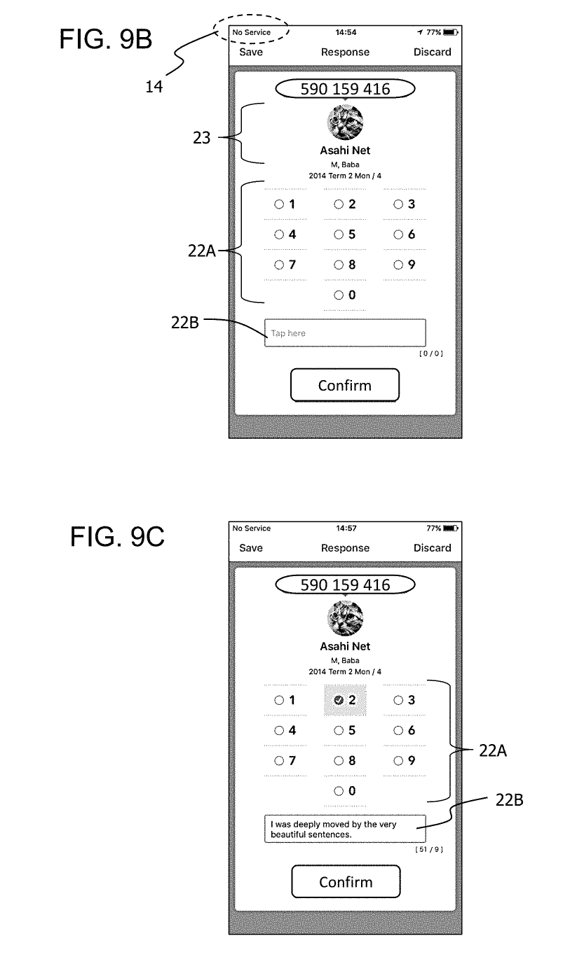

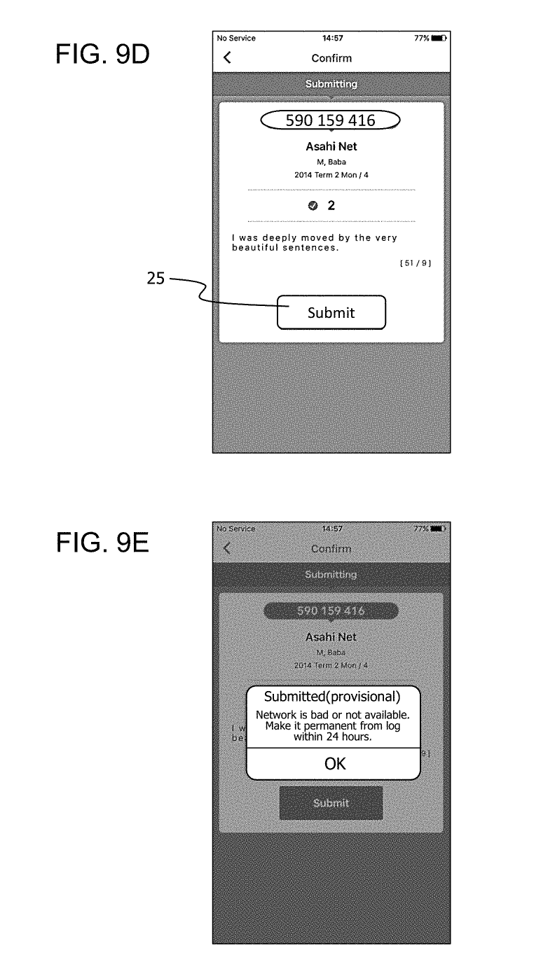

FIGS. 9A to 9C illustrate an input screen (FIG. 9A), a response form (FIG. 9B), and a screen (FIG. 9C) in which a response is created when the important communication A is not available (step S07, Y).

The input screen (FIG. 9A) is similar to the input screen (FIG. 8A) except that the indication 14 indicating whether a communicable environment is established indicates a non-communicable range.

The response form of FIG. 9B is a response form displayed when the responding terminal 2 and the surveying server 3 are in a non-communicable state and the advance distribution is present (step S13, Y: FIG. 3B), and is created and displayed on the basis of the reception data distributed in advance and stored in the database of the responding terminal 2.

When the important communication B is available (step S10: FIG. 3B), the responder inputs a number (number 2) 24 selected for a question orally asked by a teacher and writes a sentence into the free description field 22B to create a response (FIG. 9C).

FIG. 9D is a confirmation screen for confirming a created response, and the responder presses the submit button 25 to transmit response data to the surveying server 3 (step S11: FIG. 3B). Here, when the important communication B is not available (step S10, N: FIG. 3B), a message of delayed submission is displayed as illustrated in FIG. 9E (step S18: FIG. 3B).

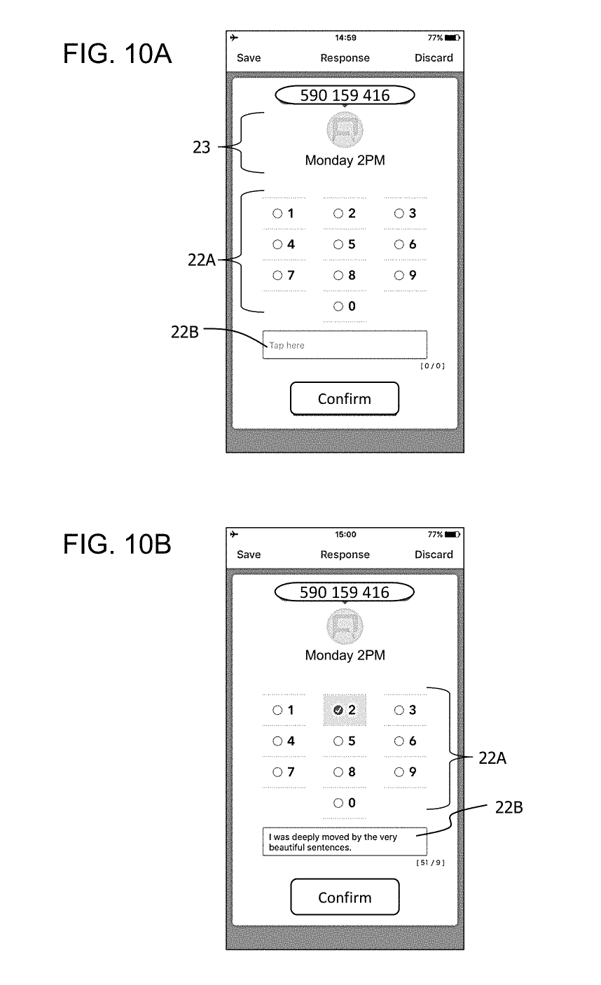

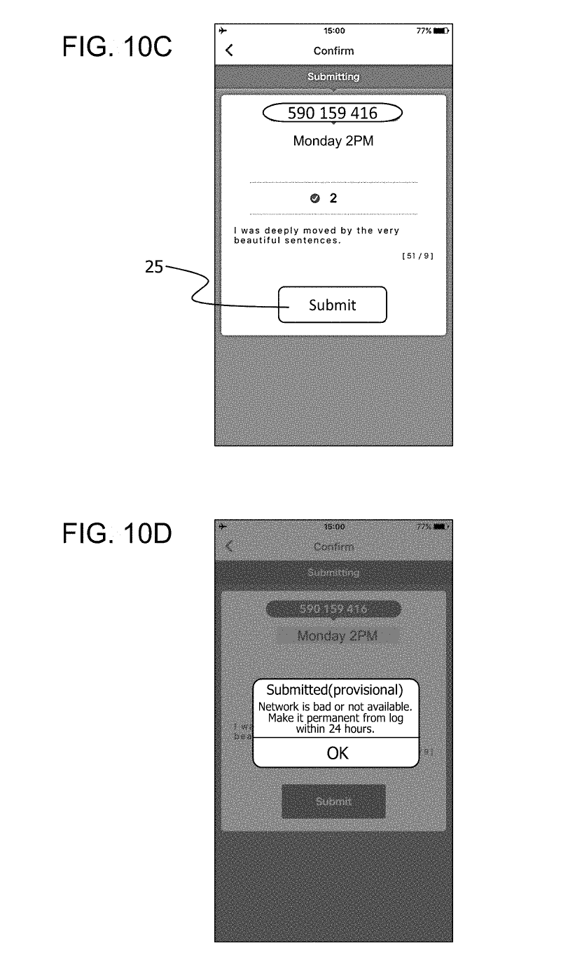

FIGS. 10A and 10B illustrate a pre-registered response form (FIG. 10A) and a screen (FIG. 10B) in which a response is created when the important communication A is not available (step S07, Y: FIG. 3A) and the advance distribution data is not present in the database 2A.

The advance distribution data is not present, the associated information (a lecture name, a teacher name, an icon, and a due date and time) is not displayed in a display area 23 of the response form, and the current time only is displayed. The form including the number keys 22 is installed in the database 2A of the responding terminal 2 as a predefined form when the control program is installed on the responding terminal 2, for example.

FIG. 10C is a confirmation screen for confirming a response, and when the submit button 25 is pressed, since the important communication B is not available (step S07, Y), a message of delayed submission is displayed similarly to FIG. 9E, as illustrated in FIG. 10D (step S18: FIG. 3B).

[(iii) Create Survey (in which Questions can be Freely Set) as Well During Attendance]

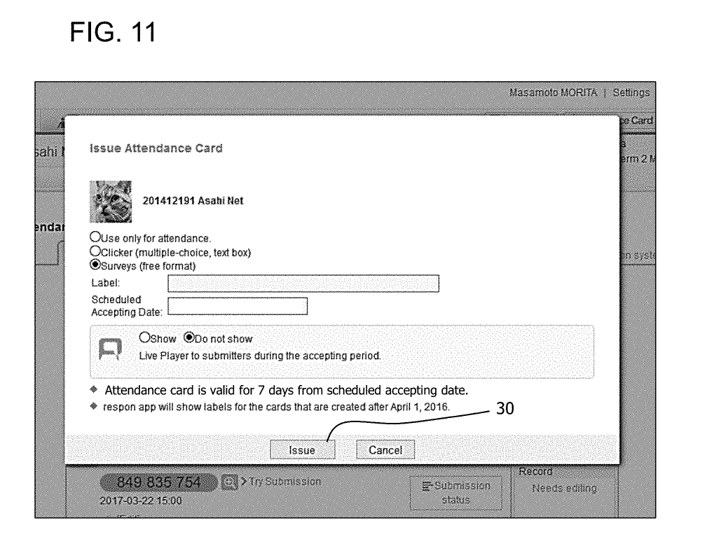

FIG. 11 is an attendance card issuance screen displayed on the questioning terminal 1 when the option “(iii) Create survey (in which questions can be freely set) as well during attendance” executed to create questions that can be freely set during attendance confirmation to ask a response to a survey is selected.

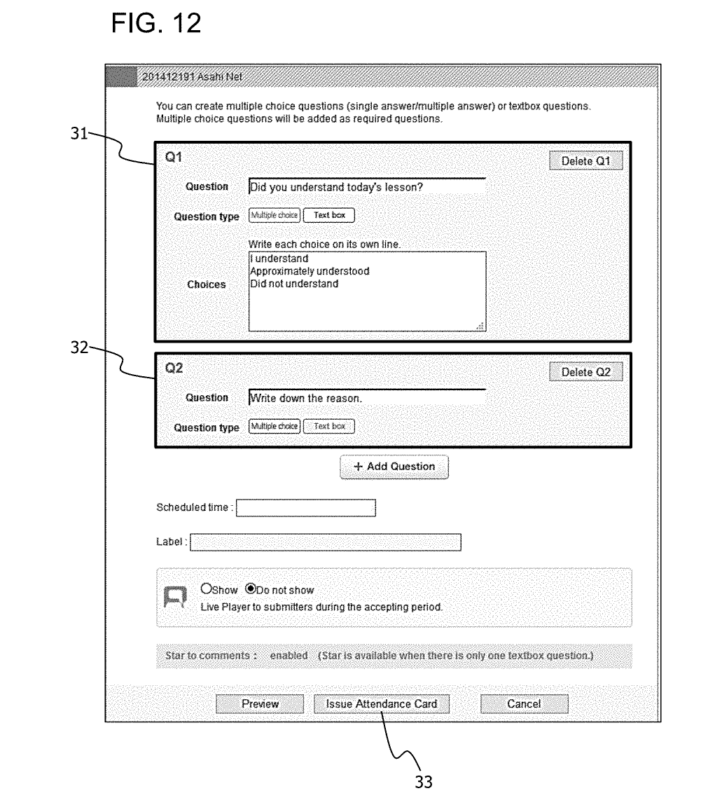

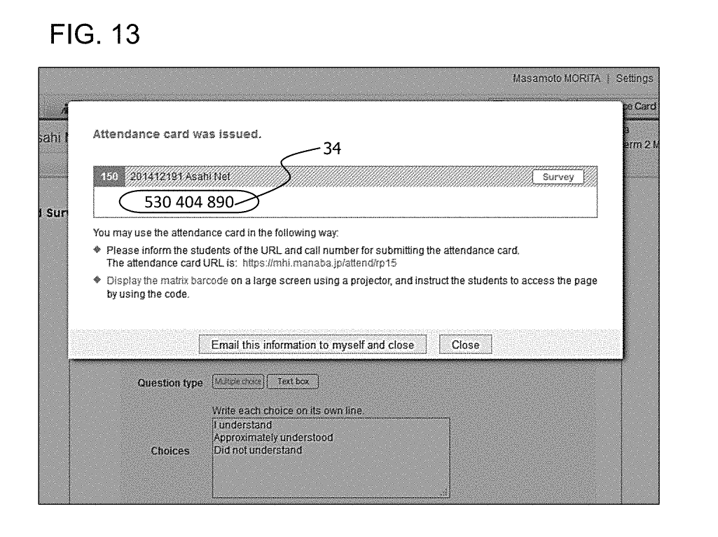

When an “issue” button 30 is pressed, a survey creation screen is displayed as illustrated in FIG. 12. In this survey creation screen, it is possible to create a plurality of question fields. In the example illustrated in FIG. 12, two question creation fields 31 and 32 are created and an attendance card issue button 33 is pressed. In this way, as illustrated in FIG. 13, a reception number 34 is assigned by the surveying server 3 as a reception identifier, and it can be confirmed that an attendance card has been issued (step S02: FIG. 3A).

In this case, a response form is registered in the survey management database 3B of the surveying server 3 in correspondence to the reception number 34. The reception number 34 is different from those used when the options “(i) Confirm attendance only” and “(ii) Create questions (predefined closed-ended questions and open-ended questions) as well during attendance” are selected, and therefore, a different response form is identified.

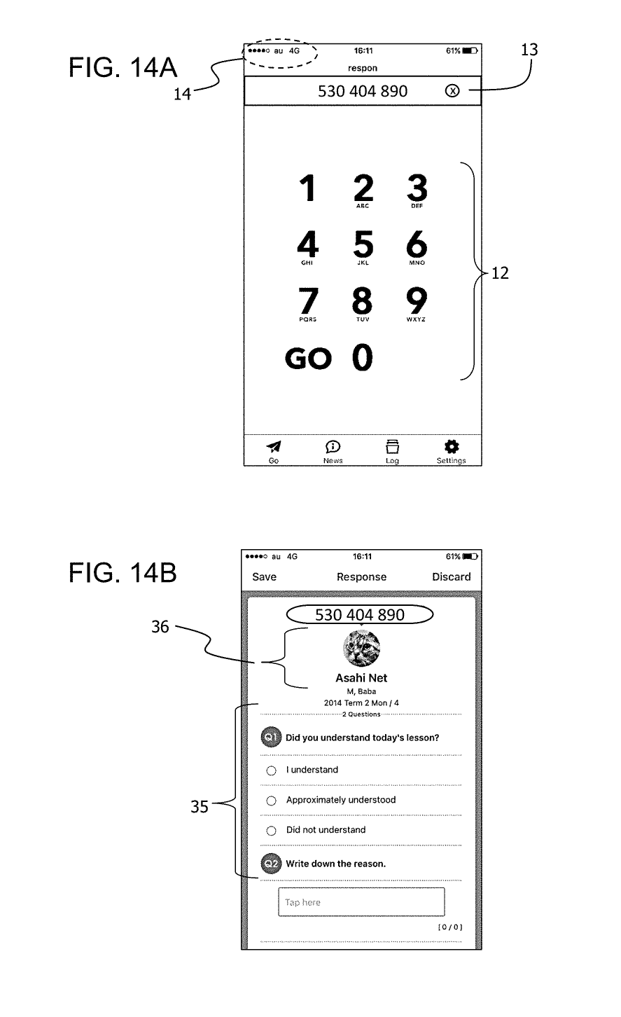

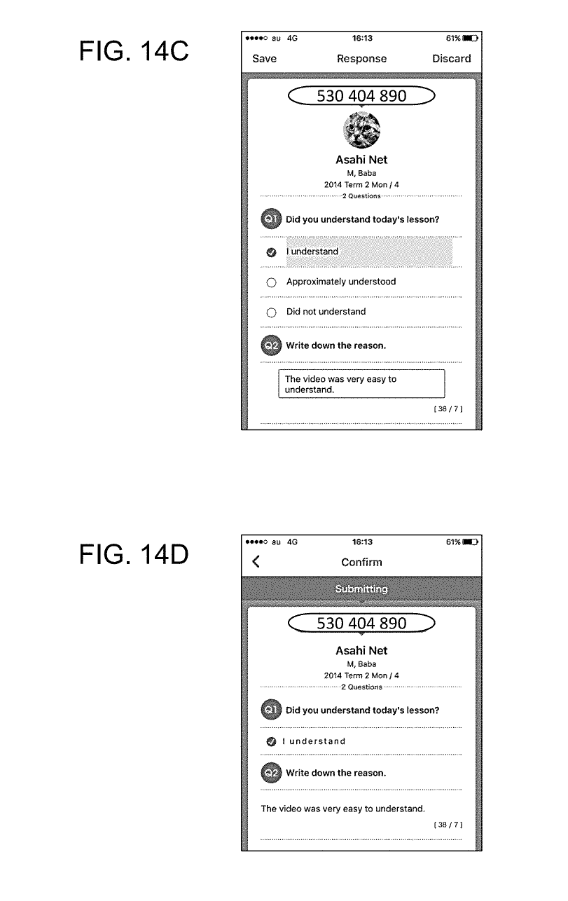

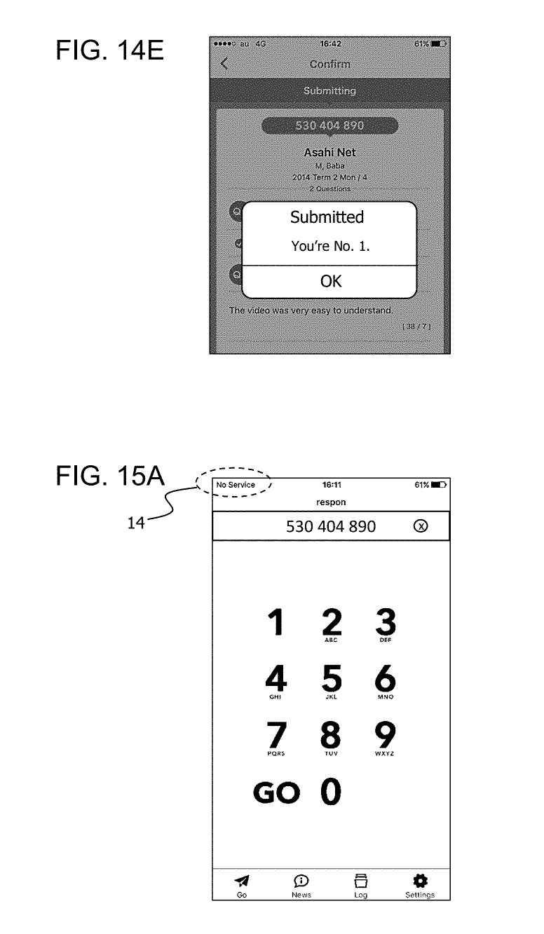

FIGS. 14A to 14C illustrate an input screen (FIG. 14A), a response form (FIG. 14B), and a screen (FIG. 14C) on which a response is created when the important communication A is available (step S07, Y: FIG. 3A).

The input screen (FIG. 14A) is similar to the input screens used when the options “(i) Confirm attendance only” and “(ii) Create questions (predefined closed-ended questions and open-ended questions) as well during attendance” are selected except for the input reception number only.

The response form of FIG. 14B is received from the database 3B of the surveying server 3 in correspondence to the input reception number when the responding terminal 2 and the surveying server 3 can communicate (step S08: FIG. 3A). The response form includes a response writing field 35 for writing a response to a question and associated information 36 including a lecture name, a teacher name, an icon, and a due date and time.

When the important communication B is available (step S10: FIG. 3B), the responder writes a response to the question (FIG. 14C).

FIG. 14D is a confirmation screen for confirming a created response, and the responder presses a submit button to transmit response data to the surveying server 3 (step S11: FIG. 3B). Subsequently, when transmission to the surveying server 3 is completed, a submission completion message is displayed (FIG. 14E), and the completion of transmission of the survey data is confirmed (step S12: FIG. 3B).

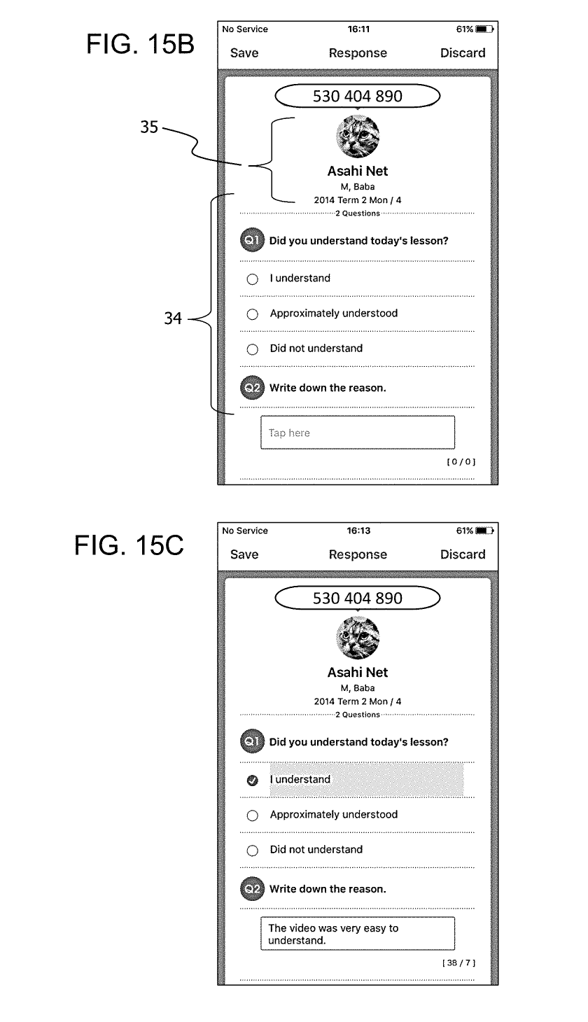

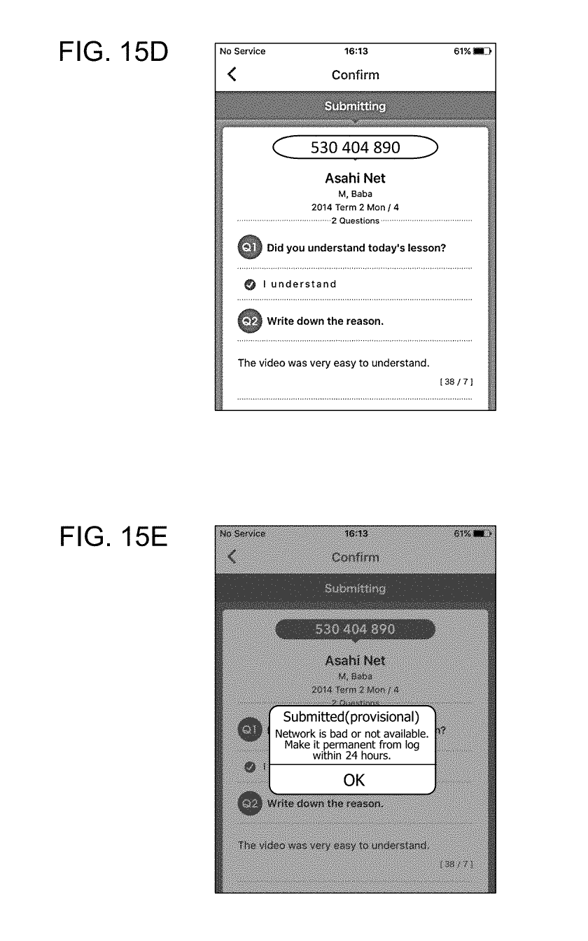

FIGS. 15A to 15C illustrate an input screen (FIG. 15A), a response form (FIG. 15B), and a screen (FIG. 15C) in which a response is created when the important communication A is not available (step S07, N: FIG. 3A).

The input screen (FIG. 15A) is similar to the input screen (FIG. 14A) displayed when the important communication A is available except that the indication 14 indicating whether a communicable environment is established indicates a non-communicable state.

The response form of FIG. 15B is a response form displayed when the responding terminal 2 and the surveying server 3 are in a non-communicable state and the advance distribution is present (step S13, Y: FIG. 3B), and is created and displayed on the basis of the reception data distributed in advance and stored in the database 2 of the responding terminal 2.

FIG. 15C illustrates a state in which a response is created in a response form. FIG. 15D is a confirmation screen for confirming a created response form (FIG. 15C), which is transmitted to the surveying server 3 as survey response data (step S11: FIG. 3B). Here, when the important communication B is not available (step S10, N: FIG. 3B), a message of delayed submission is displayed as illustrated in FIG. 15E (step S18: FIG. 3B).

[Checking Function]

Here, in the description of the embodiment, when the responder and the surveying server 3 are in a communicable environment in the [important communication A], the responder can access the surveying server 3 using the “reception number” informed from the questioner to acquire survey information registered latest from the survey management database 3B.

That is, the responder inputs the “reception number” using the responding terminal 2 to transmit the same to the surveying server 3. In this case, when a survey corresponding to the transmitted “reception number” is not present, the surveying server 3 returns a notification of an error to the responding terminal 2.

However, even when it is determined that the corresponding survey is not present, there are many cases in which the responder inputs erroneous numbers for the “reception number” due to key input errors. Moreover, in the [important communication A], when it is not possible to communicate with the surveying server 3, it is not possible to confirm whether the reception number input by the responder is correct (whether numbers are pressed erroneously or the corresponding survey information is present).

In order to obviate such an inconvenience, a check digit is embedded in the reception number which is the reception identifier as a checking identifier. The check digit is a number added according to a predetermined algorithm. That is, a simple checking function is added to the number itself to determine whether the number is input correctly. Such checking is performed offline. In this way, the possibility that the reception number is input correctly increases although it is not 100% correct.

When a character string other than numbers is used as the reception identifier, a validity checking method appropriate for that may be used (for example, a checksum may be used as a checking identifier).

In either case, it is possible to generate a checking identifier when inputting a reception number (or a reception identifier which uses a character string other than numbers) and to check the validity of the input reception identifier on the basis of the generated checking identifier and a checking identifier embedded in the reception number (or the reception identifier).

[Execution of Important Communication A]

In the description of the embodiment, even when the survey information distributed in advance is saved in the database 2A of the responding terminal 2 (step S13, Y: FIG. 3B), or the survey is “predefined,” it is preferable to try the [important communication A].

This is because the survey at the time of advance distribution may be removed or the response form may be changed depending on the intention of the questioner.

When the survey is a predefined response form defined in advance and the survey information distributed in advance is not present in the database 2A (step S13, N: FIG. 3B), it is preferable to try the [important communication A] in order to obtain the “associated information”.

[Embedding in Reception Number]

Unlike the embodiment in which a response form is distributed in advance, a plurality of predefined response forms are prepared as another embodiment. Moreover, the questioner may select one predefined response form from the plurality of predefined response forms.

That is, information (information indicating the type of forms such as form 1, form 2, or the like) indicating the type of response forms is embedded in a portion of the “reception number” as an identifier with respect to each of the plurality of response forms. Moreover, the plurality of predefined response forms are saved in advance in the database 2A of the responding terminal 2 of the responder registered in the questioner/responder identification database 3A. The predefined response forms may be saved in the database 2A when a control program for executing the survey system of the present invention is installed.

The questioner notifies the responder of the “reception number” in step S02 of the process flow in FIG. 3A. In this way, the responder can read a response form having the notified “reception number” from the plurality of predefined response forms saved in the database 2A of the responding terminal 2 and display the same on the responding terminal 2.

In such a case, it is possible to display the response form on the responding terminal 2 without accessing the surveying server 3 (that is, without executing the important communication A).

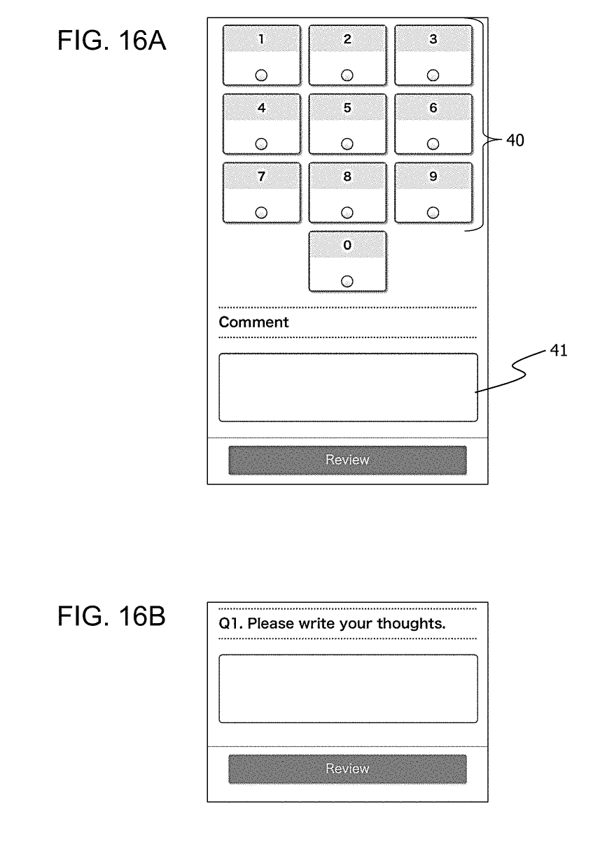

For example, in order to improve versatility, a response form which does not contain text as illustrated in FIG. 16A or a response form which is frequently used as illustrated in FIG. 16B may be defined in advance. In this way, the convenience increases. The response form illustrated in FIG. 16A includes number keys 40 of 0 to 9 for single selection and a free description field 41 and does not include a question or the like.

FIG. 16B illustrates a form which asks for impressions only and which provides a high versatility. The questioner may prepare a number of predefined response forms which are frequently used.

Such predefined response forms as illustrated in FIGS. 16A and 16B can be used as effective surveys by orally delivering the same when the questioner and the responder are in the same place (physical space).

When the survey information distributed in advance is not present in the responding terminal and the communication with the surveying server is not available, a response may be created using a form including only a text area in which text can be freely written as the predefined response form as illustrated in FIG. 16B.

It is not advantageous to embed information on a question format, the questions or the like of the survey in the “reception number” in advance as information associated to the response survey described above to distinguish predefined response forms because the number of digits of the reception number increases.

[Measures Against Delayed Submission]

Here, as described above, in an environment where radio connection is not established between the responding terminal 2 and the surveying server 3, it is not possible to perform the [important communication B] for transmitting a survey response from the responding terminal 2 to the surveying server 3. Therefore, indication of the delayed submission, and a message such as “Your card is saved due to poor communication state. Please try transmission in good communication state within 24 hours” are displayed on the responding terminal 2 (FIG. 6C and the like).

In this regard, the present invention provides a measure against a case in which the [important communication B] is not available, which is one of the features of the present invention.

That is, the present invention solves this problem by saving created response information in the database 2A of the responding terminal 2 and transmitting response data to the surveying server 3 when an environment where the [important communication B] is available is created. This process itself is similar to performing “transmission” when it is possible to transmit a “non-transmitted email” in the email transmission in the past.

However, in the case of delayed submission where a survey response is transmitted later than a deadline, another problem that is the questioning terminal 1 may be unable to acquire the “information associated to the response” correctly occurs. In contrast, the present invention provides a feature that information lost due to delayed submission is compensated.

A case in which two students A and B submit responses to a “survey for confirming attendance” will be considered. Although the two students have submitted responses to the survey approximately at the same time (12 o'clock, for example) in the class hours, the student A resulted in normal submission (the survey response was submitted within the deadline) whereas the student B failed in the [important communication B] and made delayed submission from a place in a communicable range five hours later.

In such a case, according to the survey result observed by a teacher, the reception date at the surveying server 3 is 12 o'clock for the student A and 17 o'clock for the student B. The reception date at the surveying server 3 does not show information that the students A and B have submitted the survey responses at the same time.

Although the above example is provided for the “survey for confirming attendance,” the same problem occurs for a survey of which the closing time is 13 o'clock. Although the student B tried to submit a survey response before the closing time, the actual reception date at the surveying server 3 is 17 o'clock. Therefore, according to this information only, it is handled as if the survey response was submitted later than the closing time.

Therefore, the present invention provides the following solving means.

[Transmission of Local Submission Time]

A general smartphone as the responding terminal 2 has a clock function.

The responding terminal itself acquires the time at which the responder tried first submission, adds the acquired time to the response information, and transmits the same to the surveying server 3. In the previous example, the student B transmits the information of 12 o'clock. The time acquired by the responding terminal 2 is referred to as a “local submission time”. In this way, the fact that the responder tried to transmit the response at that time is recorded and transmitted.

[Reception after Closing Time]

This function is provided together with the “transmission of local submission time”. In a general survey system, the response information received after the questioner closes the response is not received. In contrast, the present invention receives delayed submission for a predetermined period after the questioner closes the survey.

For example, the reception time when the response of which the local submission time is earlier than 13 o'clock is transmitted as delayed submission after the questioner closes the survey at 13 o'clock is referred to delayed submission time.

Even when the delayed submission after the closing time is permitted, rather than receiving the delayed submission unlimitedly, a deadline on which the questioner wants to start aggregating the surveys or a predetermined period is set so that delayed submission is expected to be completed.

Although a response received during a delayed submission reception period is received even when the local submission time is the same as the closing time or the local submission time is later than the closing time, the fact that the response is submitted after the closing time is saved in the database 3C of the surveying server 3. In contrast, when the local submission time is earlier than the closing time, it is determined that the important communication B is not available and the response is received as it is.

[Validity of Local Submission Time]

Unlike the surveying server 3, the responding terminal 2 generally has a function of changing the terminal time. Therefore, the terminal time can be set arbitrarily by the user. Due to this, it is not possible to guarantee that the local time is correct.

In order to solve such an inconvenience, the GPS (Global Positioning System) information is acquired at the timing at which the local submission time is acquired. Since the GPS information includes time information which is not able to be changed by the user, by comparing the time and the local submission time, it is possible to guarantee the accuracy of the clock of the terminal 2.

This may be checked by an application program of the responding terminal 2, and the local submission time and the time acquired by the GPS may be transmitted to the surveying server 3 and the questioner may make determination on the basis of the local submission time and the GPS time.

[Detection of Change in Time]

An application being activated in the responding terminal 2 acquires the time every predetermined period (for example, every 10 second). The collected time is set and saved in the following order, for example.

| Ex) Collected time | [Order] |
|---|---|
| 2014 Aug. 11 18:00:10 | [1] |
| 2014 Aug. 11 18:00:20 | [2] |

The time is continuously collected when the application is activated in the responding terminal 2, and the collected time information is transmitted to the surveying server 3 when communication with the surveying server 3 is available.

If the clock is not manipulated, when the time is sorted according to the “Order,” the time does not go back to the past. If the time goes back to the past, it is determined that the user (that is, the responder) has manipulated the terminal clock, and for example, the submitted data is invalidated.

Rather than transmitting the collected time information to the surveying server 3, the application program in the responding terminal 2 may make determination and issue a warning.

[Additional Function for Realizing “Attendance Confirmation”]

Next, an additional function when a survey is performed for the purpose of “attendance confirmation” will be discussed.

In the case of a survey for confirming attendance, a responder may be unable to send a survey response if the responder does not know the reception number notified from a questioner. In order for the responder to know the reception number, the questioner and the responder need to be in the same physical space (classroom) in the same period (class hours). Moreover, the reception completion date described above is important. This is because the time of the reception completion date will be between the time at which the reception number is reported and the time at which the questioner closes the reception. This can be a proof that the responder and the questioner share the same time (class hours).

When the correct reception completion date is not acquired due to delayed submission, the local time may be submitted as an alternatively. In this way, it is possible to determine whether the responder is in the same physical space as the questioner at the same time.

However, since one can submit the survey at any place if one knows the reception number, a person who does not attend the class may be handled as an attendant by revealing the reception number using other means.

Therefore, when a smartphone is used as the responding terminal 2, information that the responder and the questioner are in the same physical space in the same period may be collected more accurately using a sensor function mounted on the smartphone.

The following means may be used to avoid such an inconvenience that a person who does not attend the class is handled as an attendant.

[GPS]

Since the GPS is independent from a network, by storing a response time and the corresponding GPS data, it is possible to guarantee that responders have replied at a very close place.

[Wi-Fi]

The SSID of the Wi-Fi near the responding terminal 2 may be collected and the common term of the SSIDs of the responders may be found. In this way, it is possible to detect whether the questioner and the responder are at a nearby place.

Moreover, different Wi-Fi access points may be allocated to respective buildings or classrooms, and the responding terminal may transmit a pair of an IP address and the SSID of Wi-Fi to which the responding terminal is connected to the surveying server 3. In this way, it is possible to detect whether the questioner and the responder are at a nearby place.

[Beacon]

The questioner may have a beacon or the beacon may be disposed appropriately inside the room where the questioner asks questions. In this way, it is possible to understand whether the questioner and the responder are in the same place by acquiring the beacon data via Bluetooth.

[Information Presented to Questioner]

After any one or all of the items of information “GPS,” “Wi-Fi,” and “Beacon” is acquired, the information presented to the questioner is “This submitter (responder) was at the same place as other submitters,” “Was not,” or “Not measurable”.

For example, when a responder submitted a response at the home rather than the classroom, if the GPS information is transmitted, the place of the home of the responder may be transmitted to the questioner. The disclosure of personal information can be avoided by transmitting information on whether the responder was at the same place or not.

When a survey was performed in a classroom, if the responder was at the same place as other responders, the following scenarios are possible.

The GPS information is plotted at the same location.

At least a portion of the acquired Wi-Fi information is the same as those of the other users.

At least a portion of the acquired beacon information is the same as those of the other users.

### INDUSTRIAL APPLICABILITY

As described in detail above, according to the present invention, even when the responding terminal 2 and the surveying server 3 are in an environment where important communications A and B are not available, it is possible to acquire survey information and to realize a survey by advance distribution of the survey information and transmission of the local submission time.

In opportunities where a number of people participate such as meetings, seminars, and classes, it is possible to obtain survey responses from participants without preparing a special communication environment and to detect the number of participants easily. Therefore, the present invention can be applied to a wide range of industries.

What is claimed is:

1. A survey system that executes a survey with respect to a plurality of terminals that gather in one or a plurality of physical spaces, the survey system comprising:
a questioning terminal that provides questions for survey;
a plurality of responding terminals that gather in the physical space and respond to the survey; and
a surveying server that is connected to the questioning terminal and the responding terminal via a network and transmits survey information created by the questioning terminal to the responding terminal, wherein
the questioning terminal creates the survey information, and
the surveying server assigns a reception identifier for specifying the survey information and distributes the survey information to the responding terminal in advance earlier than the reception identifier being notified to the responding terminal when the responding terminal and the surveying server are in a communicable range.

2. The survey system according to claim 1, wherein
the surveying server has a database in which the questioning terminal and the responding terminal that responds to the survey are registered, and
the surveying server transmits the survey information in advance to the responding terminal registered in the database.

3. The survey system according to claim 1, wherein
the responding terminal transmits the survey response to the surveying server within a period in which the terminals gather in the physical space or in a later period when the responding terminal is in a communication environment where the responding terminal is able to connect to the surveying server.

4. The survey system according to claim 1, wherein
the survey information includes a response form and information associated thereto, and the associated information has information on a person who provides the questions for the survey using the questioning terminal.

5. The survey system according to claim 1, wherein
when providing the questions for the survey, the questioning terminal selects one response form from a plurality of predefined response forms and embeds information for specifying the selected response form in the reception identifier.

6. The survey system according to claim 1, wherein
a checking identifier which enables checking of validity of the reception identifier is embedded in the reception identifier, and the responding terminal generates a checking identifier when inputting the reception identifier and checks the validity of the input reception identifier on the basis of the generated checking identifier and the checking identifier embedded in the reception identifier.

7. The survey system according to claim 1, wherein
when the responding terminal creates a survey response and transmits the survey response to the surveying server, and when a communication connection with the surveying server is not available, the responding terminal saves a current time as a local submission time, and
the responding terminal transmits the survey response with the local submission time attached when the communication connection with the surveying server becomes available.

8. The survey system according to claim 7, wherein
the responding terminal or the surveying server determines the validity of the local time by comparing the local time with a time acquired by GPS.

9. The survey system according to claim 1, wherein
the responding terminal transmits data unique to a place where the responding terminal is present to the surveying server together with the survey response.

10. The survey system according to claim 9, wherein
the unique data is position information acquired by GPS, an SSID of Wi-Fi, an IP address, or beacon data acquired via Bluetooth or the like.

11. The survey system according to claim 4, wherein
the response form includes a predefined response form having a defined form and an open-ended response form in which a questioner is able to freely set the content of the survey.

12. The survey system according to claim 11, wherein
when survey information distributed in advance is not present in the responding terminal and communication with the surveying server is not available, a response is created using a form including only a text area in which text is able to be freely written as the predefined response form.

13. A non-transitory computer-readable storage medium storing therein a program for controlling execution of a survey in a survey system including: a questioning terminal that provides questions for survey; a plurality of responding terminals that gather in one or a plurality of physical spaces and respond to the survey; and a surveying server that is connected to the questioning terminal and the responding terminal via a network and transmits survey information created by the questioning terminal to the responding terminal,
the program comprising:
causing the questioning terminal to create the survey; and
causing the surveying server to assign a reception identifier for specifying the survey information and distribute the survey information to the responding terminal in advance earlier than the reception identifier being notified to the responding terminal when the responding terminal and the surveying server are in a communicable range.

14. A survey responding terminal in a survey system that executes a survey, the survey responding terminal being provided in plurality and gathering in one or a plurality of physical spaces, wherein
each of the survey responding terminals is connected to a questioning terminal that creates survey information and a surveying server that transmits the survey information created by the questioning terminal via a network, and
each of the survey responding terminals includes a communication unit that specifies the survey information created by the questioning terminal and receives the survey information distributed by the surveying server in advance earlier than notification of the reception identifier assigned by the surveying server when the communication unit and the surveying server are in a communicable range.
